(19) United States
(12) Patent Application Publication
(10) Pub. No.: US 2026/0039174 A1
(43) Pub. Date: Feb. 5, 2026

(54) ELECTRIC MOTOR ROTOR CARRIER WITH INTEGRATED POSITION SENSOR RING

(71) Applicant: Schaeffler Technologies AG & Co. KG, Herzogenaurach (DE)

(72) Inventor: Jacob Sheradin, North Canton, OH (US)

(21) Appl. No.: 18/794,386

(22) Filed: Aug. 5, 2024

(51) Int. Cl. H02K 11/215; G01D 5/14

(52) U.S. Cl. CPC H02K 11/215; G01D 5/142

(57) ABSTRACT

An annular magnetic ring may be integrated with the rotor carrier of the electric motor. The annular magnetic ring may include tracks which define words. A sensor array segment of the electric motor may be aligned with and read the words from the tracks. The tracks may repeat in a polar pattern across for each electrical rotation. The angular resolution within the electrical rotations may be determined from the words for controlling the electric motor.

### TECHNICAL FIELD

The present disclosure generally relates to electric motors, and more particularly, to rotor structures of the electric motors.

### BACKGROUND

Some designs of electric motor controllers require accurate knowledge of rotational position to maximize performance and efficiency. Rotor position is measured by a rotor position sensor (RPS). The rotor position sensor increases the packaging complexity of the electric motor. Therefore, it would be advantageous to provide a device, system, and method that cures the shortcomings described above.

### SUMMARY

An annular magnetic ring is described, in accordance with one or more embodiments of the present disclosure. The annular magnetic ring may include: a plurality of tracks, wherein the plurality of tracks are defined on an inner diameter of the annular magnetic ring, wherein the plurality of tracks define a plurality of words based on a magnetization of the plurality of tracks, wherein the plurality of words are axially defined along the annular magnetic ring, wherein the plurality of tracks are formed in a polar array, wherein the plurality of tracks are repeated in the polar array across a plurality of arc segments.

In some aspects, the annular magnetic ring includes a ferromagnetic material.

In some aspects, the plurality of tracks are axially offset and radially aligned to adjacent of the plurality of tracks.

In some aspects, the annular magnetic ring defines at least six of the plurality of arc segments.

In some aspects, the techniques described herein relate to an annular magnetic ring, wherein the plurality of words are coded.

In some aspects, the plurality of words are coded using one of binary code or reflected binary code.

In some aspects, the plurality of tracks include magnetic north and magnetic south representing 0-bits and 1-bits within the plurality of words.

In some aspects, an angular resolution of the plurality of words is based on the plurality of tracks and the plurality of arc segments.

A rotating assembly is described, in accordance with one or more embodiments of the present disclosure. The rotating assembly may include: an annular magnetic ring including: a plurality of tracks, wherein the plurality of tracks are defined on an inner diameter of the annular magnetic ring, wherein the plurality of tracks define a plurality of words based on a magnetization of the plurality of tracks, wherein the plurality of words are axially defined along the annular magnetic ring, wherein the plurality of tracks are formed in a polar array, wherein the plurality of tracks are repeated in the polar array across a plurality of arc segments; a rotor carrier, wherein the annular magnetic ring is disposed radially inwards of and axially aligned with the rotor carrier; and a rotor core, wherein the rotor core is disposed radially outwards of and axially aligned with the rotor carrier, wherein the annular magnetic ring and the rotor core are affixed to the rotor carrier.

In some aspects, the rotor carrier includes a body section, wherein the annular magnetic ring is disposed radially inwards of and axially aligned with the body section, wherein the rotor core is disposed radially outwards of and axially aligned with the body section, wherein the annular magnetic ring and the rotor core are affixed to the body section.

In some aspects, the rotor carrier includes a flange section, and a hub section, wherein the flange section extends radially outwards from the body section, wherein the hub section extend radially inwards from the body section, wherein the flange section and the hub section are disposed at opposing axial ends of the body section.

In some aspects, the rotor core includes a plurality of stacks of lamination and a plurality of permanent magnets.

In some aspects, the plurality of permanent magnets define a plurality of pole-pairs of the rotor core, wherein the plurality of pole-pairs are associated with the plurality of arc segments.

An electric motor is described, in accordance with one or more embodiments of the present disclosure. The electric motor may include: a rotating assembly including: an annular magnetic ring including: a plurality of tracks, wherein the plurality of tracks are defined on an inner diameter of the annular magnetic ring, wherein the plurality of tracks define a plurality of words based on a magnetization of the plurality of tracks, wherein the plurality of words are axially defined along the annular magnetic ring, wherein the plurality of tracks are formed in a polar array, wherein the plurality of tracks are repeated in the polar array across a plurality of arc segments; a rotor carrier, wherein the annular magnetic ring is disposed radially inwards of and axially aligned with the rotor carrier; and a rotor core, wherein the rotor core is disposed radially outwards of and axially aligned with the rotor carrier, wherein the annular magnetic ring and the rotor core are affixed to the rotor carrier; a stator, wherein the stator is disposed radially outwards of and axially aligned with the rotor core; and a sensor array segment, wherein the rotating assembly is configured to rotate relative to the stator and the sensor array segment, wherein the sensor array segment is disposed radially inwards of and axially aligned with the annular magnetic ring, wherein the sensor array segment is configured to read the plurality of words.

In some aspects, the electric motor includes a motor housing, wherein the sensor array segment is affixed to the motor housing.

In some aspects, the sensor array segment axially extends across the plurality of tracks.

In some aspects, the sensor array segment is circumferentially aligned with at least one of the plurality of words.

In some aspects, the sensor array segment is circumferentially aligned with each of the plurality of words within one of the plurality of arc segments.

In some aspects, the sensor array segment does not abut the annular magnetic ring.

In some aspects, the electric motor is an electric generator.

### BRIEF DESCRIPTION OF THE DRAWINGS

The numerous advantages of the disclosure may be better understood by those skilled in the art by reference to the accompanying figures in which:

FIG. 1A depicts a perspective view of a annular magnetic ring, in accordance with one or more embodiments of the present disclosure.

FIG. 1B depicts a front view of the annular magnetic ring, in accordance with one or more embodiments of the present disclosure.

FIG. 1C depicts example words and the associated angular resolution defined within an arc segment of the annular magnetic ring, in accordance with one or more embodiments of the present disclosure.

FIG. 2A depicts a perspective view of a rotating assembly with the annular magnetic ring, in accordance with one or more embodiments of the present disclosure.

FIG. 2B depicts a cross-section view of the rotating assembly, in accordance with one or more embodiments of the present disclosure.

FIG. 3A depicts a cross-section view of an electric motor with the rotating assembly, in accordance with one or more embodiments of the present disclosure.

FIGS. 3B-3C depict simplified views of the annular magnetic ring and a sensor array segment of the electric motor, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed an electric motor rotor carrier with integrated position sensor ring. An annular magnetic ring may be integrated with the rotor carrier of the electric motor. The annular magnetic ring may include tracks which define words. A sensor array segment of the electric motor may be aligned with and read the words from the tracks. The tracks may repeat in a polar pattern across for each electrical rotation. The angular resolution within the electrical rotations may be determined from the words for controlling the electric motor.

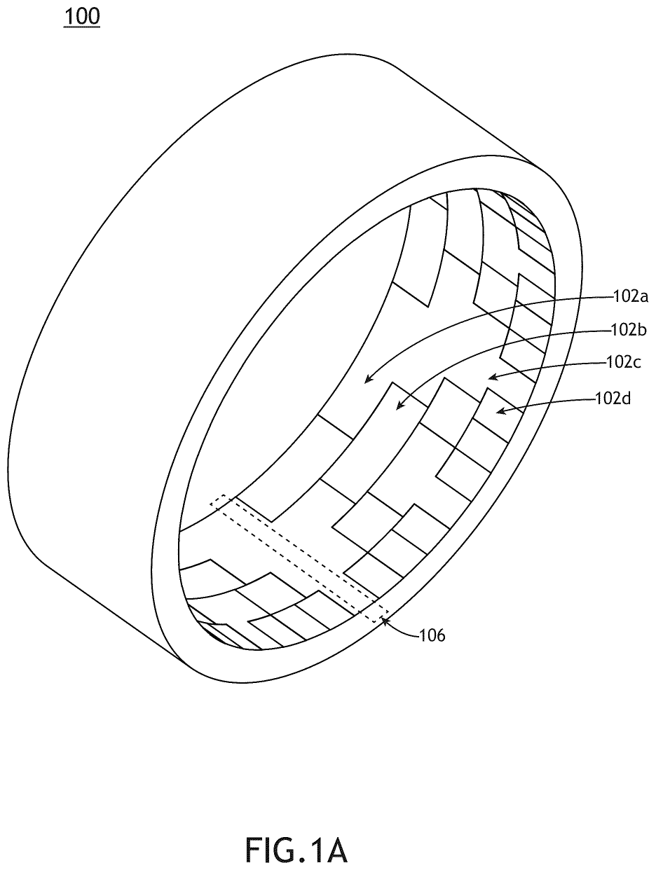

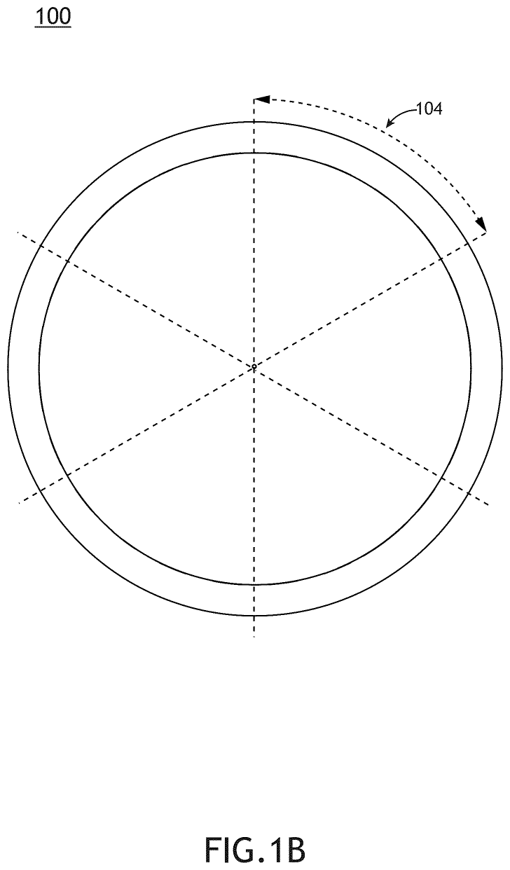

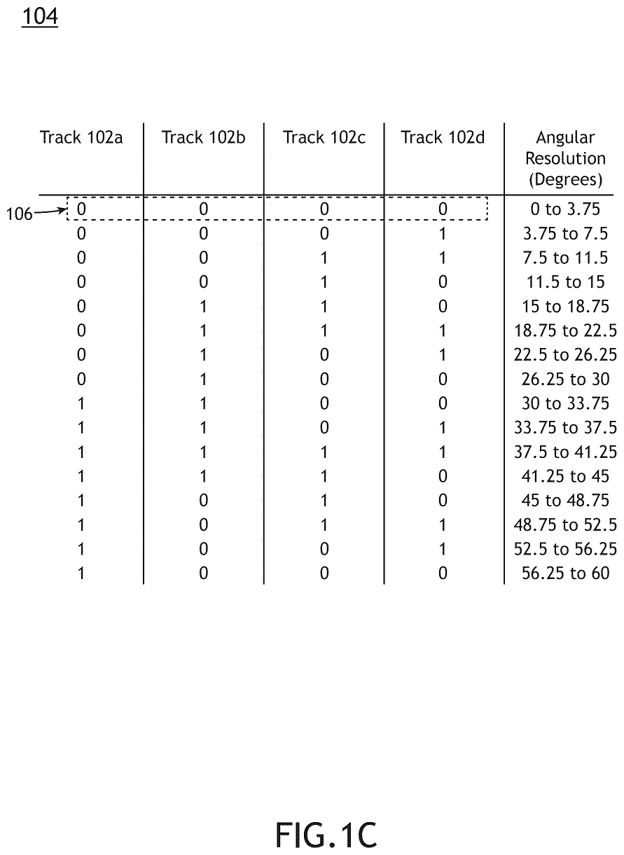

FIGS. 1A-1C depict an annular magnetic ring 100, in accordance with one or more embodiments of the present disclosure. The annular magnetic ring 100 may be an annular ring. The annular magnetic ring 100 may include an inner diameter and an outer diameter. The inner diameter and the outer diameter may define the annular shape of the annular magnetic ring 100.

The annular magnetic ring 100 may include tracks 102. The tracks 102 may be defined on the inner diameter of the annular magnetic ring 100. The tracks 102 may also be defined on the outer diameter of the annular magnetic ring 100, although this is not intended to be limiting. The tracks 102 may be axially offset and radially aligned to adjacent of the tracks 102.

The annular magnetic ring 100 may include any number of the tracks 102, such as, but not limited to, four, five, six, seven, or more. For example, the annular magnetic ring 100 is depicted with a first track 102a, a second track 102b, a third track 102c, and a fourth track 102d, although this is not intended to be limiting.

The tracks 102 are formed in a polar array. The polar array may be about a center axis of the annular magnetic ring 100. The tracks 102 may repeat in the polar array across arc segments 104.

The annular magnetic ring 100 may define any number of the arc segments 104. For example, the annular magnetic ring 100 may define six, seven, eight, or more of the arc segments 104. It is contemplated that the annular magnetic ring 100 may define at least six of the arc segments 104.

The sum of the arc segments 104 may be 360-degrees. For example, the annular magnetic ring 100 is depicted with six of the arc segments 104 which each occupy 60-degrees totaling up to the 360-degrees of the annular magnetic ring 100, although this is not intended to be limiting.

Each of the arc segments 104 may be associated with one electrical rotation of the annular magnetic ring 100. The electrical rotation of the annular magnetic ring 100 may refer to rotation from north to south as a rotor rotates. Each mechanical rotation of the annular magnetic ring 100 may include multiple of the electrical rotations. A mechanical rotation of the annular magnetic ring 100 may refer to a full revolution of 360-degrees. For a full mechanical rotation to occur, the annular magnetic ring 100 may rotate through several of the electrical rotations. The number of the electrical rotations per mechanical rotation may be based on the number of the arc segments 104.

The annular magnetic ring 100 may be made of a ferromagnetic material, such as, but not limited to, a ferrite magnet. The tracks 102 may be magnetized using the ferromagnetic material.

The tracks 102 may define words 106. The words 106 may be defined based on the magnetization of the tracks 102. The words 106 may be bit-words. The tracks 102 may include magnetic north and magnetic south representing a 0-bit and a 1-bit within the words 106. The specific 0-bit and 1-bit associated with magnetic north and magnetic south is not intended to be limiting, so long as the bit values are maintained consistent for the tracks 102. For example, magnetic north may refer to either 0-bit or 1-bit, with magnetic south referring to the other of the 0-bit or 1-bit.

The words 106 may include any number of bits-per-word. Each of the tracks 102 may define one bit within the words 106. The number of bits-per-word may be based on the number of the tracks 102. For example, the words 106 are depicted with four of the bits-per-word, although this is not intended to be limiting. Similarly, the total number of the words 106 may be 2 to the power of the tracks 102. For example, four, five, six, or seven of the tracks 102 may define sixteen, thirty-two, sixty-four, or one-hundred and twenty-eight, respectively, of the words 106.

The words 106 may be axially defined along the annular magnetic ring 100. Each bit within the words 106 may be circumferentially aligned and axially offset from adjacent of the bits within the words 106. The words 106 may be circumferentially adjacent to adjacent of the words 106 around the circumference of the annular magnetic ring 100.

The words 106 may generate a magnetic field which is unique to each of the words 106. The words 106 may be coded using a coding scheme. The coding scheme may include, but is not limited to, binary code, reflected binary code (i.e., Gray-code), or the like. For example, the tracks 102 are depicted as coding the words 106 using reflected binary code, although this is not intended to be limiting.

The words 106 may be associated with an angular resolution within the arc segments 104. The angular resolution of the words 106 may refer to a range of angles at which the words 106 are located within the arc segments 104. The angular resolution may be based on the number of the tracks 102 and the number of the arc segments 104. The angular resolution defined for each of the words 106 may be 360-degrees divided by the number of the arc segments 104, divided by two to the power of number of the tracks 102. For example, the angular resolution of the words 106 may be 3.75 degrees where the annular magnetic ring 100 includes six of the arc segments 104 and four of the tracks 102. In this example with four of the tracks 102 and six of the arc segments 104, the words 106 may define angular resolutions from 0 to 3.75 degrees, incrementing by 3.75 for each subsequent of the words 106, up to 56.25 to 60 degrees, although this is not intended to be limiting. It is contemplated that the annular magnetic ring 100 may include various permutations in the number of the tracks 102 and the arc segments 104 such that the specific values provided for the angular resolution is not intended to be limiting.

The pattern of the words 106 may repeat across each of the arc segments 104 in the polar array. In this regard, the words 106 may indicate the angular resolution within the arc segments 104 but may not indicate to which of the arc segments 104 the annular magnetic ring 100 is angularly positioned within the mechanical rotation.

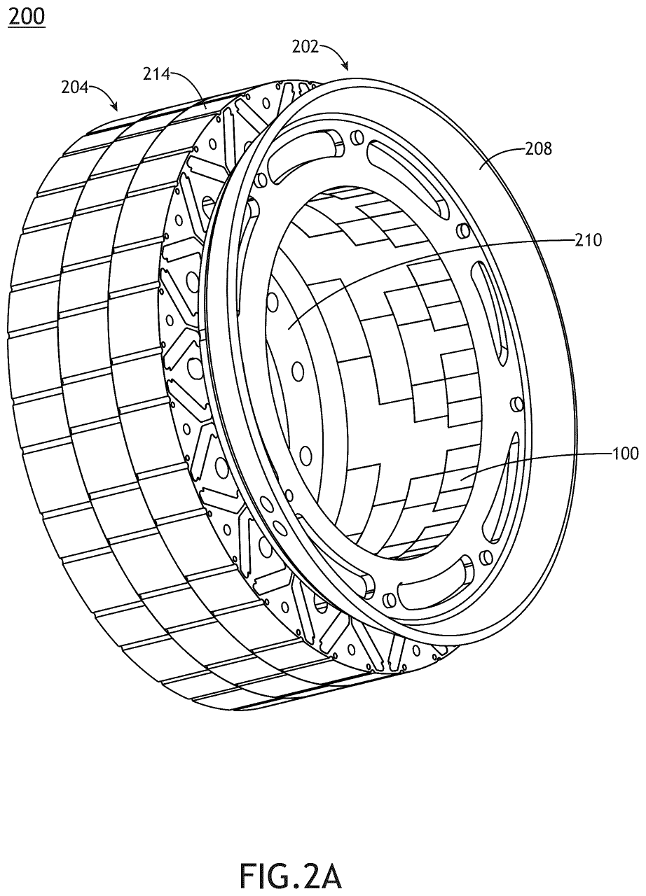

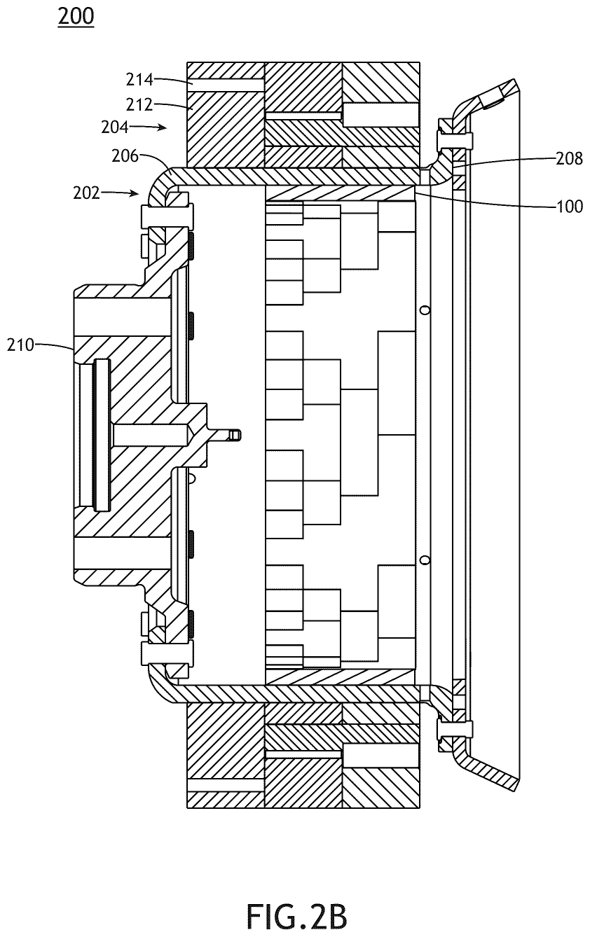

FIGS. 2A-2B depict a rotating assembly 200, in accordance with one or more embodiments of the present disclosure. The rotating assembly 200 may include the annular magnetic ring 100, a rotor carrier 202, and/or a rotor core 204. The annular magnetic ring 100 may be a position sensor ring which is integrated with the rotor carrier 202.

The rotor carrier 202 may be a rotor hub. The rotor carrier 202 may include a body section 206, a flange section 208, and/or a hub section 210. The body section 206 may be radially and axially disposed between the flange section 208 and the hub section 210. The flange section 208 may extend radially outwards from the body section 206. The hub section 210 may extend radially inwards from the body section 206. The flange section 208 and the hub section 210 may be disposed at opposing axial ends of the body section 206. The rotor carrier 202 may be bell-shaped. An inner diameter of the body section 206 may be accessible from the axial end defining the flange section 208.

The annular magnetic ring 100 may be disposed radially inwards of and axially aligned with the rotor carrier 202. For example, the annular magnetic ring 100 may be disposed radially inwards of and axially aligned with the body section 206 of the rotor carrier 202. The annular magnetic ring 100 may be disposed axially between the flange section 208 and the hub section 210. The annular magnetic ring 100 may abut the inner diameter of the body section 206. The inner diameter of the body section 206 may radially support the annular magnetic ring 100. The body section 206 may provide a centripetal force on the annular magnetic ring 100 during rotation of the rotating assembly 200. The body section 206 may prevent the annular magnetic ring 100 from failing under high rotations per minute by the centripetal force. The annular magnetic ring 100 may be mechanically weak, particularly where the annular magnetic ring 100 is made of a ferrite material. The rotor carrier 202 may support the annular magnetic ring 100 and prevent failure.

The rotor core 204 may be disposed radially outwards of and axially aligned with the rotor carrier 202. For example, the rotor core 204 may be disposed radially outwards of and axially aligned with the body section 206 of the rotor carrier 202.

The annular magnetic ring 100 and/or the rotor core 204 may be affixed to the rotor carrier 202. The annular magnetic ring 100 and/or the rotor core 204 may be affixed to body section 206 of the rotor carrier 202. For example, the annular magnetic ring 100 and/or the rotor core 204 may be affixed to body section 206 of the rotor carrier 202 by a shrink fit, a press fit, a circumferential spring, a keyway, by staking to the rotor core 204, or the like.

The rotor core 204 may include stacks of lamination 212 and permanent magnets 214. The stacks of lamination 212 may be laminated steel. The permanent magnets 214 may be disposed within cavities defined by the stacks of lamination. The permanent magnets 214 may define pole-pairs of the rotor core 204. For example, pairs of the permanent magnets 214 may be arranged in a V-shape. The V-shape may define one-half of a pole-pair of the rotor core 204. Two sets of the pairs of the permanent magnets 214 may then define one pole-pair of the rotor core 204. Each of the pole-pairs of the rotor core 204 may be associated with one electrical rotation and/or with the arc segments 104. For example, there may be a one-to-one match between the pole-pairs and the arc segments 104. The remainder of the rotating assembly 200 may also be symmetric across each of the arc segments 104.

The permanent magnets 214 may also be circumferentially skewed along the axial length of the rotor core 204. The permanent magnets 214 may be circumferentially skewed by a skew angle. The circumferential skew along the axial length may be beneficial to change the position of the poles along the axial length (e.g., for reducing torque ripple).

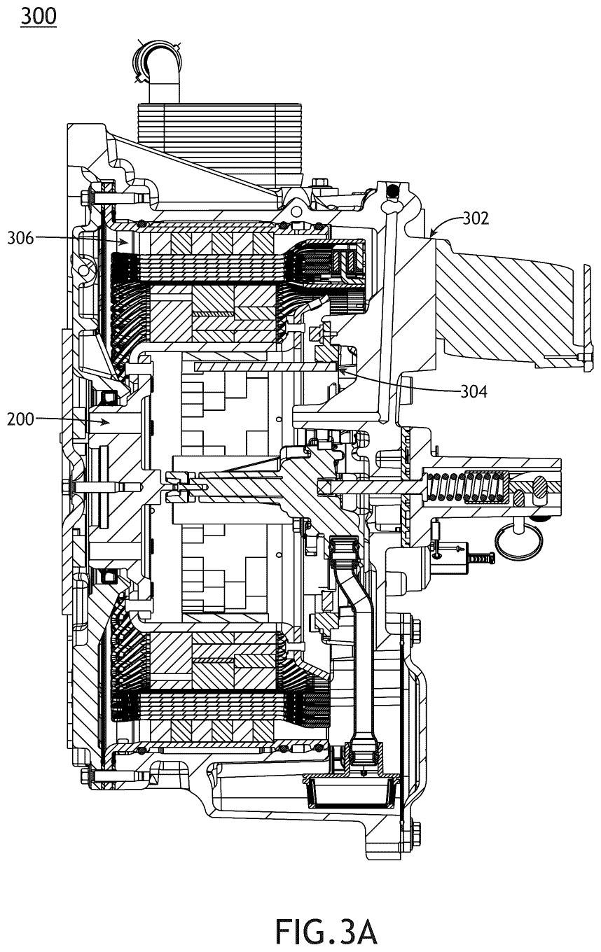

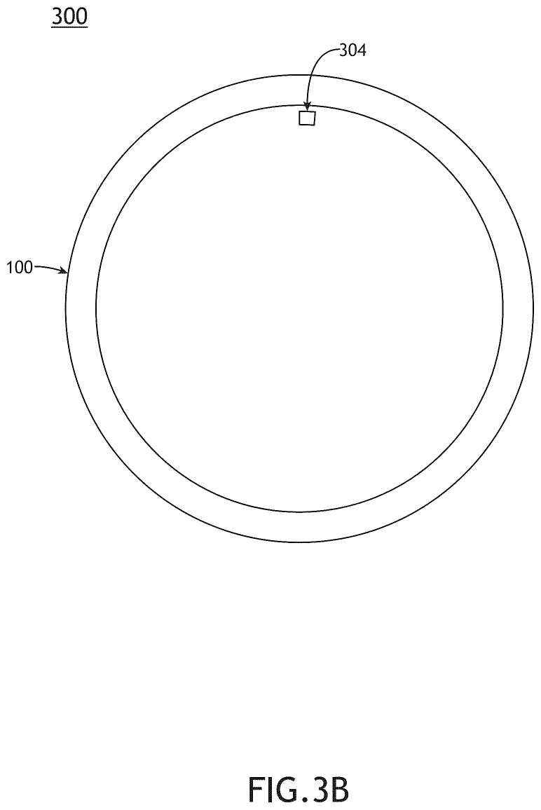

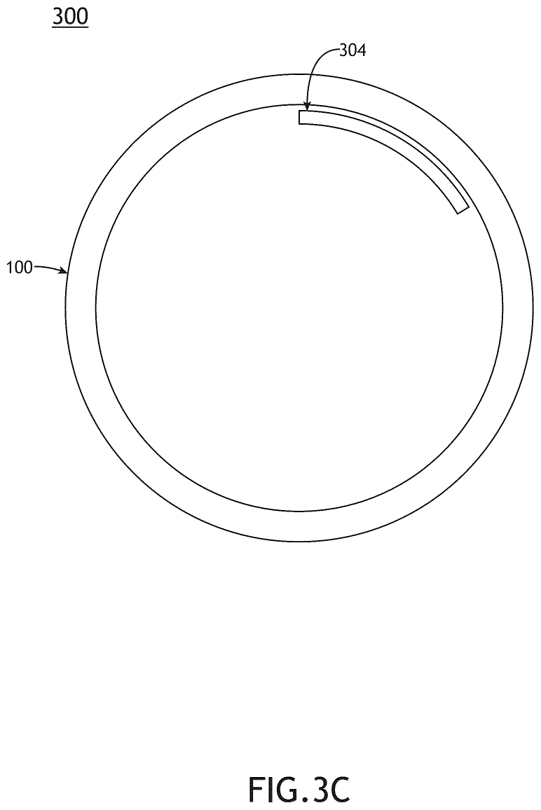

FIGS. 3A-3C depict an electric motor 300, in accordance with one or more embodiments of the present disclosure. The electric motor 300 may include the rotating assembly 200, a motor housing 302, a sensor array segment 304, and/or a stator 306.

The motor housing 302 may house one or more components of the electric motor 300. For example, the motor housing 302 may house the rotating assembly 200, the sensor array segment 304, and/or the stator 306. The motor housing 302 may be made of a select material. For example, the motor housing 302 may be made of aluminum, or the like.

The sensor array segment 304 may be affixed to the motor housing 302. For example, one or more bosses on the motor housing 302 may hold the sensor array segment 304.

The rotating assembly 200 may be configured to rotate relative to the motor housing 302, the sensor array segment 304, and/or the stator 306. The sensor array segment 304 may be a rotor position sensor (RPS) stator and the annular magnetic ring 100 may be a rotor position sensor (RPS) rotor. The sensor array segment 304 may sense the rotation of the rotating assembly 200 via the annular magnetic ring 100.

The sensor array segment 304 may be disposed radially inwards of and axially aligned with the annular magnetic ring 100.

The sensor array segment 304 may be configured to read the words 106 from the annular magnetic ring 100. The sensor array segment 304 may axially extend across each of the tracks 102. The sensor array segment 304 may axially extend across each of the tracks 102 to enable the sensor array segment 304 to read the words 106 from the tracks 102. The sensor array segment 304 may have a magnetic pickup associated with each of the tracks 102 of the annular magnetic ring 100. The sensor array segment 304 may have pickup heads that axially lineup with each of the tracks 102. For example, the sensor array segment 304 may include hall effect sensors or the like which may determine the rotational position of the annular magnetic ring 100. The sensor array segment 304 may generate a reading of the magnetic field of the annular magnetic ring 100.

The sensor array segment 304 may determine the angular resolution based on the words 106. For example, the words 106 can be decoded into the angular resolution of the annular magnetic ring 100 within the electrical rotation. Notably, the words 106 may not provide the absolute position within the mechanical rotation. Thus, the annular magnetic ring 100 may resolve the electrical position within the pole-pair but may not resolve the mechanical position of the annular magnetic ring 100.

The sensor array segment 304 may be a segment and not an annulus. In this regard, the sensor array segment 304 does not form an annular shape but rather a segmented shape. The segmented shape of the sensor array segment 304 may be beneficial to provide additional package room radially within the body section 206 of the rotor carrier 202.

The sensor array segment 304 only needs to circumferentially span enough of an electrical rotation to determine the angular resolution. The sensor array segment 304 may be circumferentially aligned with at least one of the words 106. The sensor array segment 304 may be circumferentially aligned with between one and all of the words 106 within one of the arc segments 104. As depicted in FIG. 3B, the sensor array segment 304 may be circumferentially aligned with as few as one of the words 106. As depicted in FIG. 3C, the sensor array segment 304 may also be circumferentially aligned with each of the words 106 within one of the arc segments 104. Increasing the number of the words 106 to which the sensor array segment 304 is circumferentially aligned may increase the span of the sensor array segment 304 and/or increase the number of the words 106 which may be simultaneously read by the sensor array segment 304. It is contemplated that increasing the number of the words 106 which may be simultaneously read by the sensor array segment 304 may be beneficial to improve the accuracy of the sensor array segment 304 and/or provide error redundancy.

The sensor array segment 304 may or may not abut the annular magnetic ring 100. For example, the sensor array segment 304 may be separated from the annular magnetic ring 100 by a gap distance. The gap distance may be in proximity, such as less than 2 mm gap distance. The gap distance may prevent the sensor array segment 304 from rubbing on the annular magnetic ring 100 during rotation of the rotating assembly 200 while ensuring the magnetic field from the tracks 102 may be sensed.

The electric motor 300 may be controlled based on the words 106 sensed by the sensor array segment 304. For example, the sensor array segment 304 may be connected to a motor controller electronics. The electric motor 300 may be a synchronous motor. The motor controller electronics may control when the electric motor 300 is energized using a lookup table to efficiently generate torque. The motor controller electronics may not require knowing where the annular magnetic ring 100 is mechanically when controlling the electric motor 300.

The stator 306 may be disposed radially outwards of and axially aligned with the rotor core 204. The stator 306 may be affixed to the motor housing 302.

The stator 306 may include a stator core, a stator winding, and the like. The stator core may be made of stacks of one or more stacks of lamination. The stator core may define one or more slots for the winding. The winding of the stator 306 may disposed in the slots of the stator core.

The electric motor 300 may be a polyphase synchronous motor. For example, the electric motor 300 may be a 3-phase motor, a 6-phase or the like.

The electric motor 300 may be an electric generator. The rotating assembly 200 may receive torque via the hub section 210. For example, the hub section 210 may be coupled to an external engine (not depicted). The rotor carrier 202 may transmit the torque to the rotor core 204. The rotor core 204, along with the rotating assembly 200, may rotate in response to the torque. The rotation of the rotor core 204 may induce a magnetic field. The magnetic field may induce an electrical current in the stator 306.

It is contemplated that the annular magnetic ring 100 and the sensor array segment 304 may provide several benefits for the electric motor 300, such as, but not limited to, a reduced bill-of-materials, reduced mechanical requirements of a rotor position sensor (RPS) rotor, and/or reduced size and material usage of rotor position sensor (RPS) stator.

The term “axial” and derivatives thereof, such as “axially,” shall be understood to refer to a direction along the axis of rotation. Further, the term “radial” and derivatives thereof, such as “radially,” shall be understood in relation to the axis. For example, “radially outwards” refers to further away from the axis, while “radially inwards” refers to nearer to the axis. The term “circumferential” and derivatives thereof, such as “circumferentially,” shall be understood in a circumference at a fixed radius in relation to the axis.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 annular magnetic ring
102 tracks
102a first track
102b second track
102c third track
102d fourth track
104 arc segments
106 words
200 rotating assembly
202 rotor carrier
204 rotor core
206 body section
208 flange section
210 hub section
212 stacks of lamination
214 permanent magnets
300 electric motor
302 motor housing
304 sensor array segment
306 stator

What is claimed:

1. An annular magnetic ring comprising:
a plurality of tracks, wherein the plurality of tracks are defined on an inner diameter of the annular magnetic ring, wherein the plurality of tracks define a plurality of words based on a magnetization of the plurality of tracks, wherein the plurality of words are axially defined along the annular magnetic ring, wherein the plurality of tracks are formed in a polar array, wherein the plurality of tracks are repeated in the polar array across a plurality of arc segments.

2. The annular magnetic ring of claim 1, wherein the annular magnetic ring comprises a ferromagnetic material.

3. The annular magnetic ring of claim 1, wherein the plurality of tracks are axially offset and radially aligned to adjacent of the plurality of tracks.

4. The annular magnetic ring of claim 1, wherein the annular magnetic ring defines at least six of the plurality of arc segments.

5. The annular magnetic ring of claim 1, wherein the plurality of words are coded.

6. The annular magnetic ring of claim 5, wherein the plurality of words are coded using one of binary code or reflected binary code.

7. The annular magnetic ring of claim 1, wherein the plurality of tracks comprise magnetic north and magnetic south representing 0-bits and 1-bits within the plurality of words.

8. The annular magnetic ring of claim 1, wherein an angular resolution of the plurality of words is based on the plurality of tracks and the plurality of arc segments.

9. A rotating assembly comprising:
an annular magnetic ring comprising:
a plurality of tracks, wherein the plurality of tracks are defined on an inner diameter of the annular magnetic ring, wherein the plurality of tracks define a plurality of words based on a magnetization of the plurality of tracks, wherein the plurality of words are axially defined along the annular magnetic ring, wherein the plurality of tracks are formed in a polar array, wherein the plurality of tracks are repeated in the polar array across a plurality of arc segments;
a rotor carrier, wherein the annular magnetic ring is disposed radially inwards of and axially aligned with the rotor carrier; and
a rotor core, wherein the rotor core is disposed radially outwards of and axially aligned with the rotor carrier, wherein the annular magnetic ring and the rotor core are affixed to the rotor carrier.

10. The rotating assembly of claim 9, wherein the rotor carrier comprises a body section, wherein the annular magnetic ring is disposed radially inwards of and axially aligned with the body section, wherein the rotor core is disposed radially outwards of and axially aligned with the body section, wherein the annular magnetic ring and the rotor core are affixed to the body section.

11. The rotating assembly of claim 10, wherein the rotor carrier comprises a flange section, and a hub section, wherein the flange section extends radially outwards from the body section, wherein the hub section extend radially inwards from the body section, wherein the flange section and the hub section are disposed at opposing axial ends of the body section.

12. The rotating assembly of claim 9, wherein the rotor core comprises a plurality of stacks of lamination and a plurality of permanent magnets.

13. The rotating assembly of claim 12, wherein the plurality of permanent magnets define a plurality of pole-pairs of the rotor core, wherein the plurality of pole-pairs are associated with the plurality of arc segments.

14. An electric motor comprising:
a rotating assembly comprising:
an annular magnetic ring comprising:
a plurality of tracks, wherein the plurality of tracks are defined on an inner diameter of the annular magnetic ring, wherein the plurality of tracks define a plurality of words based on a magnetization of the plurality of tracks, wherein the plurality of words are axially defined along the annular magnetic ring, wherein the plurality of tracks are formed in a polar array, wherein the plurality of tracks are repeated in the polar array across a plurality of arc segments;
a rotor carrier, wherein the annular magnetic ring is disposed radially inwards of and axially aligned with the rotor carrier; and
a rotor core, wherein the rotor core is disposed radially outwards of and axially aligned with the rotor carrier, wherein the annular magnetic ring and the rotor core are affixed to the rotor carrier;
a stator, wherein the stator is disposed radially outwards of and axially aligned with the rotor core; and
a sensor array segment, wherein the rotating assembly is configured to rotate relative to the stator and the sensor array segment, wherein the sensor array segment is disposed radially inwards of and axially aligned with the annular magnetic ring, wherein the sensor array segment is configured to read the plurality of words.

15. The electric motor of claim 14, comprising a motor housing, wherein the sensor array segment is affixed to the motor housing.

16. The electric motor of claim 14, wherein the sensor array segment axially extends across the plurality of tracks.

17. The electric motor of claim 14, wherein the sensor array segment is circumferentially aligned with at least one of the plurality of words.

18. The electric motor of claim 17, wherein the sensor array segment is circumferentially aligned with each of the plurality of words within one of the plurality of arc segments.

19. The electric motor of claim 14, wherein the sensor array segment does not abut the annular magnetic ring.

20. The electric motor of claim 14, wherein the electric motor is an electric generator.
